(19) United States
(12) Patent Application Publication
(10) Pub. No.: US 2025/0269284 A1
(43) Pub. Date: Aug. 28, 2025

(54) HYBRID DIALOG TREE GENERATION AND ACCESS

(71) Applicant: Meta Platforms, Inc., Menlo Park, CA (US)

(72) Inventor: Mokhtar Mohamed KHORSHID, Kirkland, WA (US)

(73) Assignee: Meta Platforms, Inc., Menlo Park, CA (US)

(21) Appl. No.: 19/053,711

(22) Filed: Feb. 14, 2025

Related U.S. Application Data
(60) Provisional application No. 63/556,696, filed on Feb. 22, 2024.

(51) Int. Cl. A63F 13/60; G06F 40/30

(52) U.S. Cl. CPC A63F 13/60; G06F 40/30

(57) ABSTRACT

Systems, apparatuses and methods provide technology that receives a first operator prompt associated with a character in a computing application, and generates, with a first machine learning model during an offline process, first responses based on the first prompt, where the first responses are dialog of the character. The technology stores the first responses into a dialog tree during the offline process, receives a second prompt associated with an end user of the computing application, generates, with the first machine learning model during the offline process, second responses to the second prompt and based on the first responses stored in the dialog tree, where the second responses are dialog of the end user, and adds the second responses to the dialog tree during the offline process.

### CROSS-REFERENCE TO RELATED APPLICATIONS

This application claims benefit of priority to U.S. Provisional Patent Application No. 63/556,696, filed on Feb. 22, 2024. The entire disclosure of the aforementioned Provisional Application is incorporated herein by reference.

### BACKGROUND

Computing systems may be applied to various contexts. For example, as computing systems have increased in speed, power and versatility, the computing systems have been widely adopted. In some contexts, the computing systems may interact with a user through various mediums and approaches.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In some aspects, the techniques described herein relate to at least one computer readable storage medium including a set of instructions, which when executed by a computing device, cause the computing device to: receive a first prompt associated with a character in a computing application; generate, with a first machine learning model during an offline process, first responses based on the first prompt, where the first responses are dialog of the character; store the first responses into a dialog tree during the offline process; receive a second prompt associated with an end user of the computing application; generate, with the first machine learning model during the offline process, second responses to the second prompt and based on the first responses stored in the dialog tree, where the second responses are dialog of the end user; and add the second responses to the dialog tree during the offline process.

In some aspects, the techniques described herein relate to a system including: one or more processors; and a memory coupled to the one or more processors, the memory including instructions executable by the one or more processors, the one or more processors being operable when executing the instructions to: receive a first prompt associated with a character in a computing application; generate, with a first machine learning model during an offline process, first responses based on the first prompt, where the first responses are dialog of the character; store the first responses into a dialog tree during the offline process; receive a second prompt associated with an end user of the computing application; generate, with the first machine learning model during the offline process, second responses to the second prompt and based on the first responses stored in the dialog tree, where the second responses are dialog of the end user; and add the second responses to the dialog tree during the offline process.

In some aspects, the techniques described herein relate to a method including: receiving a first prompt associated with a character in a computing application; generating, with a first machine learning model during an offline process, first responses based on the first prompt, where the first responses are dialog of the character; storing the first responses into a dialog tree during the offline process; receiving a second prompt associated with an end user of the computing application; generating, with the first machine learning model during the offline process, second responses to the second prompt and based on the first responses stored in the dialog tree, where the second responses are dialog of the end user; and adding the second responses to the dialog tree during the offline process.

### BRIEF DESCRIPTION OF THE DRAWINGS

The various advantages of the examples will become apparent to one skilled in the art by reading the following specification and appended claims, and by referencing the following drawings, in which:

FIG. 1 is an example of a dialog process according to an example of the disclosure;

FIG. 2 is an example of a dialog generation process according to an example of the disclosure;

FIG. 3 is method of removing nodes from a dialog tree according to an example of the disclosure;

FIG. 4 is method of generating new layers for a dialog tree during an online process according to an example of the disclosure;

FIG. 5 is method of generating a dialog tree and accessing the dialog tree according to an example of the disclosure;

FIG. 6 illustrates an example network environment associated with a social-networking system according to an example of the disclosure;

FIG. 7 illustrates an example social graph according to an example of the disclosure; and

FIG. 8 illustrates an example computer system according to an example of the disclosure.

### DESCRIPTION EXAMPLE

Dialog is a cornerstone of communication in different contexts. Computer games include storytelling that rely on animated characters speaking words, uttering sounds, adjusting facial expressions, gesturing, etc. to convey a particular scene. Other computer applications rely on dialog. For example, virtual reality applications (e.g., training for a different field, education, tourism, retail, entertainment) may include massive amounts of dialog for different purposes and to increase user experience as well as engagement.

Previously existing computing architectures may be unable to expediently and efficiently generate dialogs for video games or other applications that involve dialog. For example, previously existing approaches include developers generating dialog trees manually. Some games and applications include a large amount of narrative and dialog text to provide players with an immersive experience. The creation and maintenance of the narrative content for moderately-sized games is a non-trivial cost in time, resources, money and quality.

The time to manually draft dialogue for a video game or other application may vary widely depending on the complexity of the game (e.g., story depth, number of characters, and the size of the development team) or application. The time may range from a few weeks for a smaller game to several months for a larger game (e.g., extensive branching storylines and dialogue options).

Some previous implementations may rely extensively on humans to author and adjust the dialog. The humans may actively draft and adjust the dialog for each character. The dialog, however, may be variable and unrealistic depending on the author. For example, several different people may actively generate the dialog for one character, causing subjective differences in style, opinion, verbiage, etc. and an incongruous experience. In some cases a single author may draft the dialog for a character. Doing so may provide consistency and a more congruous user experience but may increase the time to complete the dialog and limit the generation of dialog in real time during game play (e.g., on the fly). That is, in either case, dialog is generated offline prior to execution of the application (e.g., video game).

In some previous implementations, a large language model (LLM) may attempt to generate dialog in real-time during an online process (e.g., during execution of the application such as the video game) based on interactions with a user. For example, the user may interact with a character in a video game, and the LLM may generate dialog based on the interaction. Doing so may increase cost and computational resources, as the LLM may be executed every time the user interacts with a character in the video game. Furthermore, such previous implementations are inefficient in that the LLM duplicates resources generating a same or similar response for similar interactions from different users playing the same game. For example, a first user may interact with a character in a first instance, and a second user may interact with the character separately from the first user in a second instance. The LLM may generate the same response for both the first user and the second user meaning that the LLM duplicates work for each of the interactions with the first and second users. That is, the LLM may not store generated responses for re-use in similar situations and/or similar interactions with users. Rather, the LLM generates a response every time a situation and/or interaction occurs.

Moreover, such previous implementations may have higher latency since the LLM repeatedly executes and may not be able to respond to each interaction in a timely manner. That is the LLM may operate too slowly to provide realistic timings for dialog (e.g., fails to operate in real time). Additionally, complications may arise if a video game is retired and no longer supported by the LLM. In such examples, the video games (or other applications) may effectively be inoperable since the LLM will not produce dialog. Further, in some cases LLMs may suffer from hallucinations and/or divulge confidential details (e.g., data leakage). That is, the LLMs provide non-sensical dialog and/or restricted information (e.g., confidential information). Accordingly, conventional implementations that rely on LLMs to generate dialog suffer from several technical issues noted above.

Some previously existing computer architectures have been proposed to reduce the production costs. For example, some previously existing computer architectures include generative artificial intelligence (GAI) (e.g., generative machine learning model). Discussed below are a few notable options that incorporate GAI. Such existing approaches have serious negative impacts that are mitigated with enhanced examples as described herein.

Some previous examples may pre-generate single-shot text assets (e.g., dialog which does not build off from previously generated dialog). Doing so may be used in games where crowds are speaking on random relevant topics, but not invariably in a coherent way. For example, non-playable characters (NPCs) may incorporate single-shot text assets (e.g., vendor NPCs may advertise wares or guard NPCs may issue warnings). Such an existing approach may incorporate GAI to produce a large list of utterances that the NPCs may articulate and state during gameplay, and a human editor may analyze the generated utterances to accept or reject (and replace with a new sentence or phrase) the utterances one-by-one. Doing so may save the editor some amount of time by offering different variations to say the same things without the editor having to create every line of text. Such existing approaches may not facilitate rich dialog and lack coherence between different utterances since the dialog is disconnected.

Some GAI models may produce text at runtime (e.g., when a user utilizes the application). Such models typically operate by priming the GAI (e.g., an LLM) with prompts providing context for characters then feeding the GAI model free text. The free text may be provided by the player in various formats (e.g., voice, typing, etc.). Doing so allows multi-turn dialog to proceed in an open-ended fashion. While this existing approach is flexible and allows freeform text to be used in games, the existing approach comes with some severe negative impacts, such as safety and integrity risk. For example, the GAI may generate text that is offensive or inappropriate. Furthermore, the existing examples may generate inaccurate responses (e.g., AI hallucinations). For example, GAI sometimes makes mistakes and results in completely out of place responses that may break the game immersion or misguide a user. Moreover, such existing approaches have significant latency. That is, GAI consumes significant resources and is not fast enough to produce text in real time and immediately as players may expect in video games and other applications. Furthermore, running LLMs (a subset of GAI) are costly due to hardware requirements. Accordingly, the enhanced examples herein define particular rules that enable the automation of specific dialog tasks that previously could only be performed subjectively by humans or sub-optimally by GAI such as LLMs. That is, examples are directed to improvements in dialog generation and implementation rather than an abstract idea. In detail, examples herein harness the powerful technology of GAI to implement a hybrid methodology for dialog generation and various applications herein. The GAI may generate realistic, coherent and congruous character dialog by building from previous dialog, operates efficiently (e.g., avoids duplicating dialog for similar interactions), reduces latency (e.g., GAI generates dialog ahead of time to avoid longer latency dialog creation during gameplay), and reduces the time to create new dialog. To do so, examples receive a first operator prompt associated with a character in a computing application, identify, with a machine learning model during an offline process, first responses based on the first operator prompt, wherein the first responses are dialog of the character, store the first responses into a dialog tree during the offline process, receive a second operator prompt associated with an end user of the computing application, generate, with the machine learning model during the offline process, second responses to the second operator prompt and based on the first responses stored in the dialog tree, wherein the second responses are associated with the end user, and add the second responses to the dialog tree during the offline process.

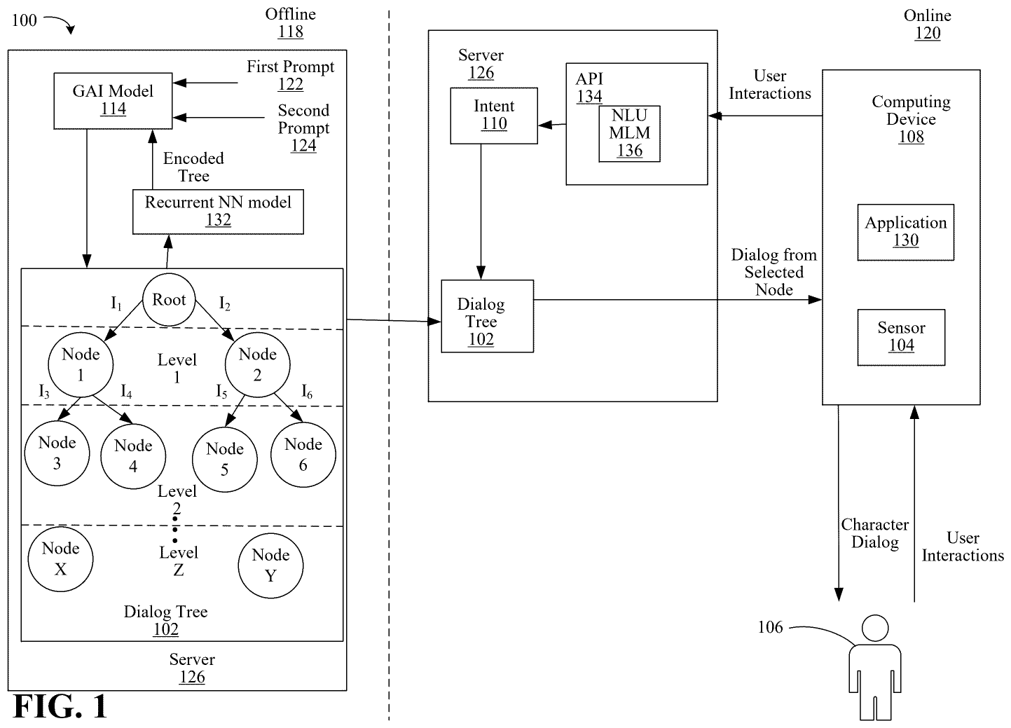

FIG. 1 illustrates a dialog process 100 to provide dialog to a user in various circumstances. For example, the dialog process 100 may form part of a video game application, movie application, interactive discussion application, customer support service application, etc. As will be described below, examples herein provide an enhanced process to generate and provide dialog in a computing system and include the enhanced examples described above. Dialog process 100 provides enhancements including lower computing overhead, lower latency operations to provide the dialog, richer dialog and real-time immersion.

The dialog process 100 may be a hybrid generation approach in that the operation includes offline 118 and online 120 aspects. The dialog process 100 incorporates GAI model 114 to generate dialogs (e.g., pre-baked NPC dialogs) offline 118. The dialog process 100 operates by generating a dialog tree 102 of limited depth. The dialog tree 102 includes a multi-party dialog (e.g., player-NPC dialog). A server 126 may execute the GAI model 114 and store the resulting dialog tree 102.

Notably the GAI model 114 may generate the dialog tree 102 offline 118. Offline 118 may occur at a time prior to a user 106 (e.g., an end user and/or current user) executing an application 130 that relies on the dialog tree 102 for dialog. Doing so may provide enhancements, such as reducing errors and increasing efficiency. For example, an operator (e.g., game developer) may prune the dialog of the dialog tree 102 and adjust the dialog prior to the dialog tree 102 being utilized (e.g., to remove poorly worded dialog, data leakage and/or AI hallucinations). Furthermore, since the dialog tree 102 is generated beforehand, during execution of the application 130 may be traversed in real time to reduce latency to provide dialog to the user 106. In some examples, a machine learning model (e.g., not illustrated) will prune nodes if the nodes contain confidential information, non-sensical information and/or AI hallucinations.

The operator inputs first prompt 122 into the server 126. For example, the server 126 may include peripherals (e.g., keyboard, mouse, video camera, audio sensor, etc.) that allows the operator to provide commands to the server 126 and input the first prompt 122. The server 126 provides the first prompt 122 to the GAI model 114. The first prompt 122 may guide the GAI model 114 to generate the dialog tree 102. The first prompt 122 may be an input or instruction given to the AI (e.g., a question, statement, or command).

In some cases, in addition to the operator or instead of the operator, another machine learning model (not illustrated) may generate the first prompt 122 based on characteristics of the application 130. For example, the another machine learning model may generate the first prompt 122 based on characters that are supposed to speak based on the dialog tree 102, location of the characters when the characters speak based on the dialog tree 102, plot of the game, purpose of the dialog, what information is to be conveyed in the dialog, etc.

The dialog tree 102 is generated based on the content that the GAI model 114 creates based on the first prompt 122. The first prompt 122 may include details relevant to the application (e.g., gameplay). The GAI model 114 may adjust the produced dialog based on the NPC and/or end user that will utter the dialog, the location, and the other factors in the first prompt 122 noted above. For example, the GAI model 114 may adjust verbiage, selected words, order of words, etc. based on the NPC that will utter the dialog. In some examples, more than one GAI model 114 may be included which each generate dialog for a different NPC. In such examples, the first prompt 122 is provided to an appropriate GAI model from the more than one GAI model 114 based on the character (e.g., a first NPC) associated with the first prompt 122.

The dialog tree 102 may be generated by consecutive prompting of the GAI model 114. As an example, an operator may prompt the GAI model 114 (e.g., LLM) with a first prompt such as “you are a shop keeper, a hero (the player) holding a sword approaches you, what are 10 different responses you can see to the hero?” Then the GAI model 114 iterates over each of the “10 responses” and repeats the prompt with the text of first-ten nodes that are inserted into the dialog tree 102. For example, the GAI model 114 may insert text into each of the first-ten nodes that states “you asked if the hero was looking for a challenge. What are 10 different responses the hero can give you?” Each of the first-ten nodes may include a different response with the same inserted text above. The operator may remove some of the first to ten nodes (prune the nodes) and continue to provide prompts to the GAI model 114 to build the dialog tree 102. The number of options may either remain the same or shrink as the dialog tree 102 is traversed (e.g., go down the dialog tree 102) to keep the size of the dialog tree 102 more manageable.

In some examples, the dialog tree 102 is also provided to the GAI model 114 as an input. To do so, some examples encode the dialog tree 102. For example, an encoded tree structure may be provided to the GAI model 114 based on the dialog tree 102. For example, a recurrent neural network (NN) model 132 may encode the dialog tree 102. In some examples, the dialog tree 102 may be encoded through an automated encoding process that changes the dialog tree 102 into vector representations for leaves and nodes.

The GAI model 114 may generate the dialog tree 102 based on several iterations with the operator. For example, node 1 and node 2 may be associated with a same first NPC. That is, the first NPC may utter dialog from the node 1 or node 2 based on execution of the application 130. For example, when application 130 is online 120, the user 106 may interact with the first NPC. The user 106 may control a playable character (PC) in the application 130. The PC may interact with the first NPC in the application 130. The server 126 may select either node 1 or the node 2 based on the interaction, and in particular based on a choice that the user 106 performs during gameplay. For example, a first choice (e.g., via the PC) by the user 106 may result in the server 126 selecting node 1 (e.g., the first NPC speaks dialogue from node 1), while a second choice (e.g., via the PC) by the user 106 may result in the server 126 selecting node 2 (e.g., the first NPC speaks dialogue from node 2). In detail, the first choice and second choice may be matched to intents that are used to determine an appropriate node to select.

Each level 1-Z of the dialog tree 102 may be associated with a different NPC and/or an end user of the application 130 during execution, where Z may be any number greater than 2. For example, after nodes 1 and 2 are generated, the operator may provide a second prompt 124 to the GAI model 114. The second prompt 124 may include an inquiry, action, selection, etc. that would follow the logical flow of the application 130. For example, the second prompt 124 may include “what would a user reply to the dialog of node 1? What would a user reply to the dialog of node 2?” Thus, level 2 of the dialog tree 102 may be actions of an end user, while level 1 of the dialog tree 102 may be dialog for the first NPC.

The dialog may progress toward a single node at any given time. The single node may be referred to as the root node. Anything above that root node may be pruned (at least until the conversation restarts again if it's repeatable). Thus, examples generate a subtree of the dialog tree 102 where the next level right under the root represents the options (nodes) that may be selected (which could be any party). If the next level is for NPC dialog, then examples will utter a response from a selected node. The end user may be able to control the NPC. If the next level is for PC dialog, then examples will select the nearest node (if applicable) to what the PC speaks (e.g., a dialog selection of the end user, action of the end user, audio of the end user, etc.). The end user may be able to control the PC. Examples then immediately move to the selected node and make the selected node the root node and repeat the above process.

The GAI model 114 may therefore generate outputs that reflect not only NPC dialog, but also PC dialog and/or end user choices. Accordingly, the GAI model 114 is trained to generate dialog of NPCs and PCs. As an example, the Natural Language Understanding (NLU) training of the GAI model 114 may be similar to the below. The examples below may be relevant to the experience and are able to be generalized to other applications. For example, a training samples provided to the GAI model 114 may include:
“What can I buy here?”->Purchase intent.
“How do I defeat the dragon?”->Quest aid intent.
Draw gun and aim it at NPC->Aggression intent.

The above training samples may be generated by an LLM and reviewed by a human before training the NLU, but the NLU may not need too many examples to be able to identify intents. The GAI model 114 may generate intents to associate with dialog. That is, the GAI model 114 may generate outputs based on the second prompt 124 which are then entered into the dialog tree 102 in a child level (level 2) of the node 1 and node 2. Level 2 comprises nodes 3-6. Thus, level 1 (node 1 and node 2) of the dialog tree 102 may include dialog of the first NPC, level 2 of the dialog tree 102 may include potential replies and/or actions of the end user, etc. to the node 1, node 2, etc. A level 3 (not illustrated) of the dialog tree 102 may include potential replies of the first NPC (or a different NPC) to the potential replies and/or actions of the end user in level 2. A level 4 (not illustrated) may include dialog of a second NPC and so forth. The dialog tree 102 may be any number of levels, each dedicated to an NPC or end user dialog, actions, replies, etc. For example, level 1 only includes nodes 1 and node 2 associated with the first NPC, level 2 includes nodes 3-6 associated with the end user, level 3 may only include nodes associated with the first NPC, etc. Node 1 for example may have potential end user replies and/or actions (e.g., via a PC) shown in nodes 3 and 4, and node 2 for example may have potential end user replies and/or actions (e.g., via the PC) shown in nodes 5 and 6.

Therefore, the participants of the application 130, including NPCs, playable characters that represent user 106 and so forth, are each represented by a character model, shown as dialog tree 102, that is primed with a character-specific prompt. That is, examples prefix the character-specific prompt with the personality and background of the character and/or NPC.

In some examples, the operator may prune the dialog tree 102. For example, the operator may review outputs of the GAI model 114 and/or the dialog tree 102 to remove any dialog and/or nodes representing AI hallucinations, data leakage and/or unacceptable information.

When the online 120 process executes, the dialog tree 102 may be accessed to determine whether an NPC is to speak or decide to stay silent. In either case, the turn moves to the next party in the dialog group. The dialog tree 102 may include numerous nodes that are not illustrated for brevity. The dialog, at authoring time, is generated from the root each time all the way until a final outcome is achieved or a certain depth of nodes is reached, in which case, the dialog line may terminate with a conclusion. The nodes 1-Y of the dialog tree 102 may include verbal utterances that are spoken by an NPC, replies by the characters, potential replies by end users, gestures of NPCs, inflections of the NPCs, facial expressions of the NPCs, etc. Thus, the nodes 1-Y may include multi-modal communication. In this example, the pointers are intents I₁-I₆ extending from the nodes. The user and NPC replies (dialog) are all contained within the nodes 1-Y, where each level is a different party and/or character. More intents may be included. In some examples, more than two intents extend from a node (e.g., the node has three or more children). The intents I₁-I₆ may be used to navigate the dialog tree 102. For example, an identified intent may be mapped to the dialog tree 102 to select a next node and corresponding dialog. Furthermore, the arrows indicate how the dialog tree 102 is traversed, which in this case is from top to bottom.

The lines generated for the player lines of the NPCs stored in the nodes 1-Y may further be associated with the intents. The “intents” match the generated lines of the nodes 1-Y to user interactions (e.g., voice utterances) to one of the lines of the dialog tree 102 (e.g., a node of the nodes 1-Y) if the application 130 (e.g., video game) uses voice interactions or any other interaction where the actions of the user are ambiguous. Intents as used in this context refers to a recognized intention from the end user (e.g., dialogue) using NLU. Recognizing intent may be particularly useful in situations where the application 130 receives freeform inputs (e.g., freeform text, audio, video, etc.) from an end user. That is, intent may be used in situations where the application 130 does not constrain the end user choices to structured and predefined options (e.g., select dialog A, dialog B, etc. from a pop up box).

Different intents may be matched to different nodes of nodes 1-Y. The same intents may be expressed in multiple different ways. For example, the utterances “hello,” “howdy” and “hi” may have the intent of “greeting.” Therefore, when an end user utters the “hello,” “howdy” and/or “hi” to a first NPC, the intent is “greeting” and is mapped to the dialog tree 102 accordingly. For example, a reply node (e.g., node 1) from the nodes 1-Y that is associated with the intent “greeting” (e.g., I₁ has the intent “greeting” and points to node 1) and is associated with the first NPC (e.g., the first level that contains Node 1 is dedicated to the first NPC) is selected. The first NPC may then utter the dialog from the reply node (e.g., dialog stored in node 1). As another example, an end user stating “I'd like that sword,” “I want to purchase the sword, and “give me the blade” to a second NPC would have the intent of “buying an item” from the second NPC. A reply node (e.g., node 3) from the nodes 1-Y that matches the intent “buying an item” (e.g., I₃ has the intent “buying an item” and points to node 3) and is associated with the second NPC (e.g., the second level that contains Node 3 is dedicated to the second NPC) is selected. The second NPC may then utter the dialog from the reply node. Thus, each of the nodes 1-Y is associated with an intent represented as the pointers to facilitate access.

That is, during operation a last selected dialog node (last dialog any NPC uttered) is maintained. New orders, verbiage, utterances, inputs, etc. from an end user are analyzed to determine the end user intent. The end user intent is matched against pointer intents of the pointers that point away from (e.g., lead to other nodes) the last selected dialog node. The closest pointer intent from the pointer intents to the end user intent is selected, and a corresponding node that the closest pointer intent leads to is selected as a current dialog node. In some examples, vectors representing the pointer intents and the end user intent are compared in vector space to determine the closest pointer intent.

The operator (e.g., human editor) may review the dialog tree 102 to make changes, prune branches, or generate additional branches at any point of the dialog tree 102. The operator may also annotate certain nodes with intents and actions as appropriate. When the operator review is complete, the dialog tree 102 becomes an asset in the application 130. More than one dialog tree 102 may be included and generated for the application 130, where each of the more than one dialog tree 102 may be for a distinct conversation.

During runtime of the application 130 (e.g., game or other application), the dialog tree 102 is used to provide and play NPC dialog lines (e.g., via Speech synthesis (TTS) or via pre-recorded assets) and either present players with choices of responses in traditional games or listen to a voice of the players and attempt to map the voice to an intent present in the dialog tree 102. In some examples, the user 106 may interact with the computing device 108 through various devices, such as a controller, joystick, keyboard, mouse, audio inputs, visual inputs, etc.

For example, the user 106 may be a player of a video game executed in part with the computing device 108. The computing device 108 may be a gaming console, computer, laptop, mobile device, smart watch, etc. In some examples, the user 106 may be playing a video game on the computing device 108 that presents NPCs discussed above.

The user 106 may provide user interactions (e.g., audio, visual cues such as gesturing, controller commands, keyboard commands, controlling peripheral devices, etc.) to the computing device 108 (e.g., a video game console). The computing device 108 includes a sensor 104 that senses the user interactions and provides the user interactions to the server 126. The computing device 108 may represent the user interactions in a computer readable format (e.g., vectors, data structures, etc.). It will be apparent that several forms of interaction and communication are supported, such as controller actuation, movements of the user 106, etc. Thus, multiple modalities may be supported by the computing device 108.

The computing device 108 may identify an intent 110 based on the user interactions. For example, characteristics (e.g., words, tones, inflections, gestures, etc.) of the user interactions may correspond to particular intents. Thus, the characteristics may be analyzed to determine the intent 110. An NLU machine learning model (MLM) 136 may execute with an API 134. The NLU MLM 136 may translate the user interactions into an intent 110. NLU MLM 136 is the ability of a system to understand the meaning and intent of user queries in everyday language. Thus, the API 134 may include the NLU MLM 136. The NLU MLM 136 uses the meaning of human language (e.g., freeform text), whether spoken or written, by analyzing the syntax, semantics, and context of sentences, enabling machines to interact with humans using natural language input like text or speech; essentially, it's the ability for a computer to “understand” what someone is saying or writing beyond just the words themselves. In other words, the NLU MLM 136 uses a combination of machine learning based on an ontology on which it is trained and rules-based classifiers to decide on the intents.

The server 126 may access the dialog tree 102 to select a node based on the intent 110 identified by the NLU MLM 136. As noted above, intent 110 may be mapped to the pointers in the dialog tree 102. Additionally, context of the user interactions, such as which NPC (e.g., first NPC, second NPC, etc.) the user 106 is interacting with, a time in the game that the interaction occurs, a nature of the interaction, a purpose of the NPC (e.g., selling wares, providing directions, guiding other NPCs, etc.) may also be analyzed to determine the selected node.

For example, the intent 110 may be matched against intents I₁-I₆. That is, a selected node from the dialog tree 102 may be selected if the pointer that points to the selected node has an intent that matches the intent 110, and is at a current level of the dialog tree 102 (e.g., initially a first level is the current level, after one round of dialog the second level is the current level and so forth until a conversation completes). The level may be incremented every time a node is selected from the dialog tree 102. For example, if node 1 is selected, the level may be incremented from one to two. Accordingly, the next node will be selected from level 2. That is, the selected node becomes the current root of a current dialog tree which is a subtree of the dialog tree 102. The subtree may be the dialog tree 102 (e.g., the main tree) with everything else outside that current root's dependents pruned off during analysis (is ignored or not considered). The current dialog tree (subtree) is analyzed during future interactions with the user 106, and pruned portions (anything outside the current root's dependents) are ignored. Doing so may streamline resources including processing power and memory while also reducing latency to execute since less nodes are searched.

Dialog from the selected node from the dialog tree 102 is provided to the computing device 108. In some examples, to provide the dialog to the user, the computing device 108 provides an audio output (e.g., a voice output on speakers) that represents the dialog from the selected node. In some examples, to provide dialog from the selected node to the user 106, the computing device 108 displays the dialog (e.g., a monitor that displays the line), and/or adjusts characteristics of the corresponding NPC (e.g., gestures, facial expressions, etc.).

In some examples, the computing device 108 executes a video game, and controls a character of the video game to speak the dialog from the selected node. For example, the computing device 108 may display a character on a display, and the character may simulate speaking of the dialog from the selected node. In some examples, the computing device 108 may determine at each node of the dialog tree 102, whether a respective character of characters of the video game are to speak or remain silent.

The computing device 108 generates a precise, high-quality dialog, with rich interactions, at a fraction of the cost to do so manually or using fully freeform AI at runtime. Thus, the dialog process 100 results in several technical enhancements over existing examples.

The process 100 may be implemented in a computing system including a memory and processor, computing system (e.g., hardware, configurable logic, fixed-function logic hardware, at least one computer readable storage medium comprising a set of instructions for execution, etc.). Any and all components of the process 100 may be implemented as a computing device, non-transitory computer readable storage medium, server, mobile device, desktop, etc.

In some examples, if a leaf (a node with no children) of the dialog tree 102 is reached, the GAI model 114 may execute in real time to provide new dialog on the fly to the user 106. In doing so, resources may be conserved for rare instances where the user 106 traverses the whole dialog tree 102 without finishing the purpose of a conversation associated with the dialog tree 102. The new dialog may be output (e.g., played through speakers, displayed on a display, etc.) to the user 106 through the computing device 108 without human intervention.

In some examples, at authoring time, the dialog of the dialog tree 102 is generated from root to leaves until an outcome is achieved or a specific depth is reached. In some examples, the computing device 108 presents players with choices of responses in traditional games or listens to the players voice and attempts to map the voices to an intent present within the tree.

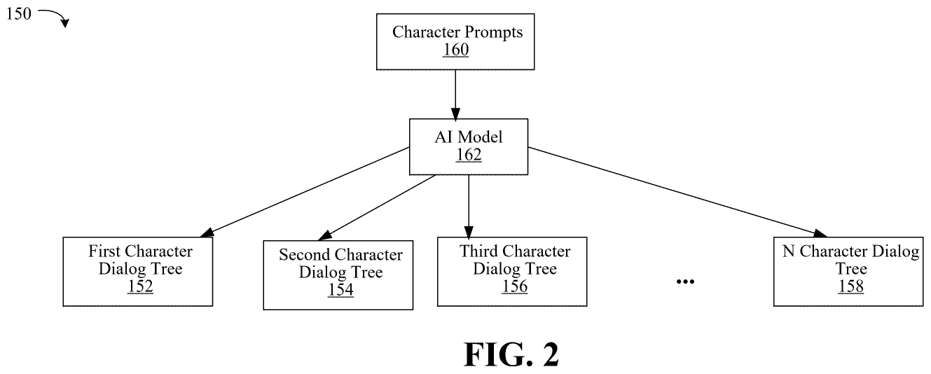

FIG. 2 illustrates a dialog generation process 150. One or more aspects of method 190 may be implemented as part of and/or in conjunction with dialog process 100. In this example, character prompts 160 (e.g., character specific prompts) are input into an AI model 162. The AI model 162 may generate different and distinct dialog trees for the different characters. For example, a first character may have dialog stored in a first character dialog tree 152, a second character may have dialog stored in a second character dialog tree 154, a third character may have dialog stored in a third character dialog tree 156, and so forth until an N character may have dialog stored in an N character dialog tree 158.

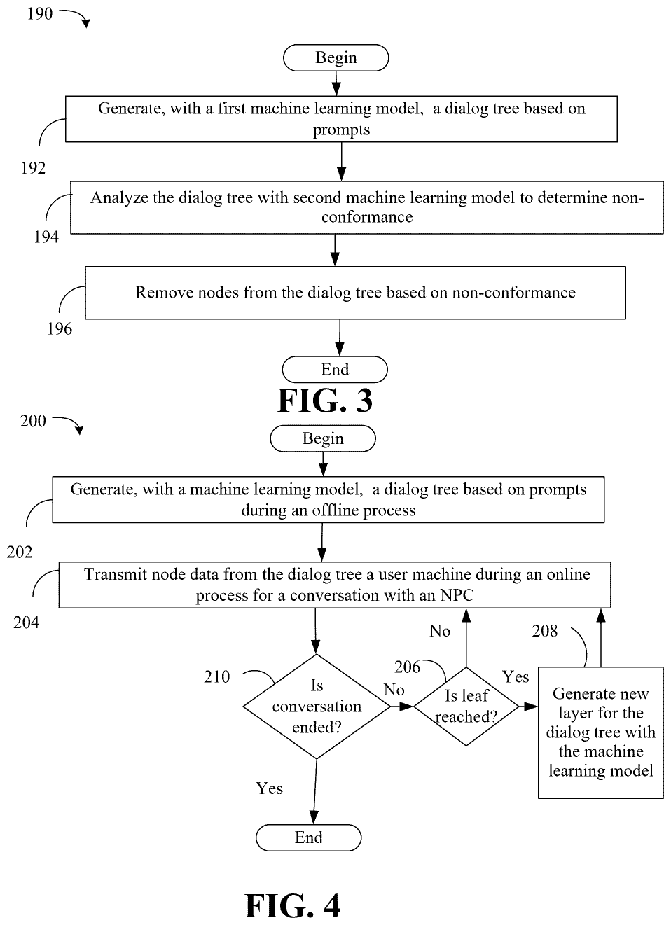

FIG. 3 illustrates a method 190 to prune a generated dialog tree. One or more aspects of method 190 may be implemented as part of and/or in conjunction with dialog process 100 (FIG. 1) and/or dialog generation process 150 (FIG. 2). Method 190 may be implemented in a computing device, computing system (e.g., hardware, configurable logic, fixed-function logic hardware, at least one computer readable storage medium comprising a set of instructions for execution, etc.).

Illustrated processing block 192 generates, with a first machine learning model (e.g., GAI), a dialog tree based on prompts. Illustrated processing block 194 analyzes the dialog tree with second machine learning model to determine non-conformance. For example, the second machine learning model may analyze the dialog tree for profanity, data leakage, non-sensical verbiage, or sensitive discussions. The method 190 further includes at illustrated processing block 196 removing nodes from the dialog tree based on the non-conformance, and specifically to remove nodes that are identified as non-conformant in processing block 194.

FIG. 4 illustrates a method 200 to add dialog to a generated dialog tree. One or more aspects of method 190 may be implemented as part of and/or in conjunction with dialog process 100 (FIG. 1), dialog generation process 150 (FIG. 2) and/or method 190 (FIG. 3). Method 200 may be implemented in a computing device, computing system (e.g., hardware, configurable logic, fixed-function logic hardware, at least one computer readable storage medium comprising a set of instructions for execution, etc.).

Illustrated processing block 202 generates, with a machine learning model, a dialog tree based on prompts during an offline process. Illustrated processing block 204 transmits node data (e.g., dialog from a selected node) from the dialog tree a user machine during an online process for a conversation with an NPC (e.g., in a video game). Illustrated processing block 210 determines if the conversation is ended. If so, the method 200 ends. Otherwise, illustrated processing block 206 determines if a leaf (has no children nodes) is reached in the dialog tree. If not, processing block 204 may execute. Otherwise, illustrated processing block 208 generate a new layer for the dialog tree with the machine learning model and then processing block 204 executes.

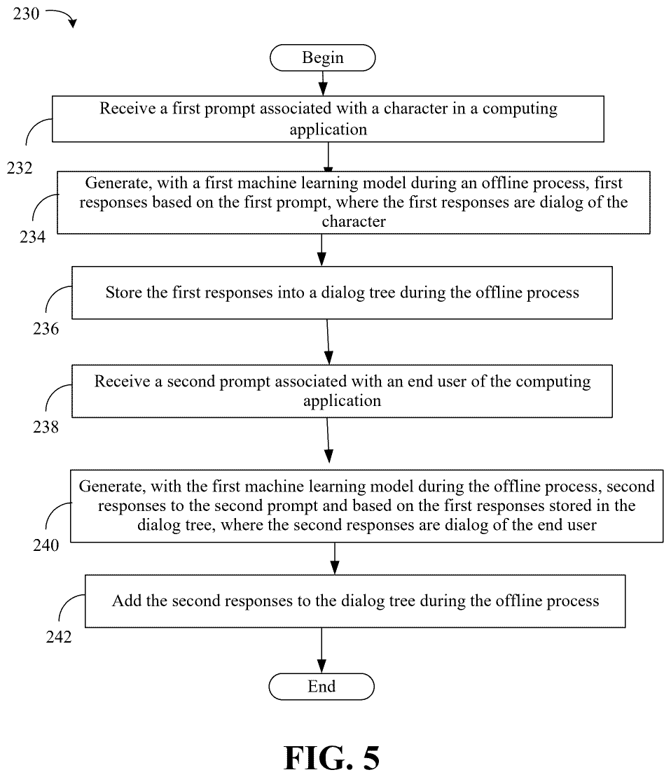

FIG. 5 illustrates a method 230 to generate and access a dialog tree. One or more aspects of method 230 may be implemented as part of and/or in conjunction with dialog process 100 (FIG. 1), dialog generation process 150 (FIG. 2), method 190 (FIG. 3) and/or method 200 (FIG. 4). Method 230 may be implemented in a computing device, computing system (e.g., hardware, configurable logic, fixed-function logic hardware, at least one computer readable storage medium comprising a set of instructions for execution, etc.).

Illustrated processing block 232 receives a first prompt associated with a character in a computing application. Illustrated processing block 234 generates, with a first machine learning model during an offline process, first responses based on the first prompt, where the first responses are dialog of the character. Illustrated processing block 236 stores the first responses into a dialog tree during the offline process. Illustrated processing block 238 receives a second prompt associated with an end user of the computing application. Illustrated processing block 240 generates, with the first machine learning model during the offline process, second responses to the second prompt and based on the first responses stored in the dialog tree, where the second responses are dialog of (predicted dialog) the end user. Illustrated processing block 242 adds the second responses to the dialog tree during the offline process.

In some examples, the method 230 identifies user interactions associated with a current user of the computing application, determines an intent of the current user based on the user interactions, identifies a dialog line from the dialog tree based on the intent, and transmit the dialog line to an electronic device of the current user. In such examples, the electronic device one or more of displays the dialog line or generates an audio output that represents the dialog line. Further, in such examples the dialog tree includes nodes and pointers that connect the nodes, wherein the nodes represent dialog and the nodes represent intents.

In some examples, the machine learning model is a generative machine learning model. In some examples, the method 230 generates third responses in real-time during an online process when a leaf of the dialog tree is accessed. In some examples, the method 230 includes generating, with a second machine learning model, the first prompt and the second prompt.

### System Overview

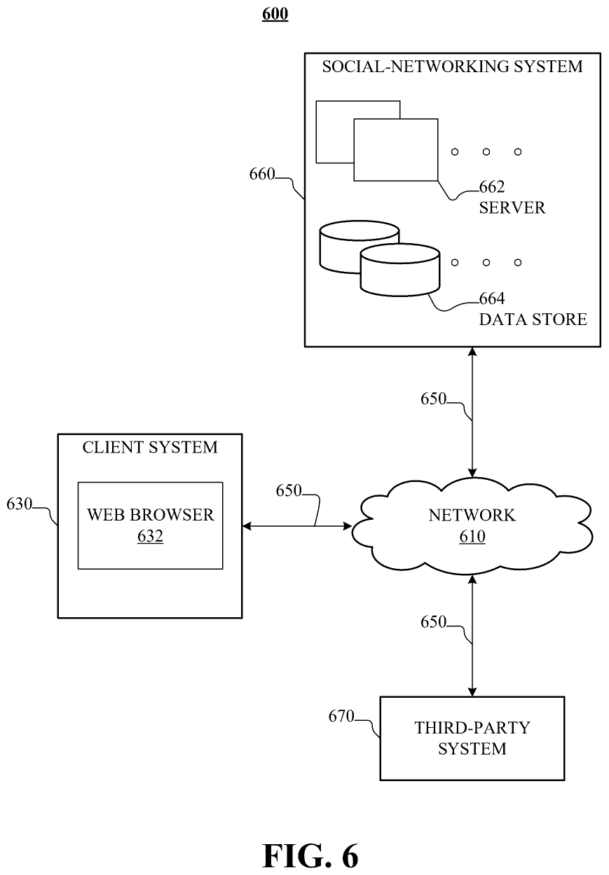

FIG. 6 illustrates an example network environment 600 associated with a social-networking system. Network environment 600 may implement one or more aspects of the dialog process 100 (FIG. 1), dialog generation process 150 (FIG. 2), method 190 (FIG. 3), method 200 (FIG. 4) and/or method 230 (FIG. 5). Already discussed.

Network environment 600 includes a client system 630, a social-networking system 660, and a third-party system 670 connected to each other by a network 610. Although FIG. 6 illustrates a particular arrangement of client system 630, social-networking system 660, third-party system 670, and network 610, this disclosure contemplates any suitable arrangement of client system 630, social-networking system 660, third-party system 670, and network 610. As an example and not by way of limitation, two or more of client system 630, social-networking system 660, and third-party system 670 may be connected to each other directly, bypassing network 610. As another example, two or more of client system 630, social-networking system 660, and third-party system 670 may be physically or logically co-located with each other in whole or in part. Moreover, although FIG. 6 illustrates a particular number of client systems 630, social-networking systems 660, third-party systems 670, and networks 610, this disclosure contemplates any suitable number of client systems 630, social-networking systems 660, third-party systems 670, and networks 610. As an example and not by way of limitation, network environment 600 may include multiple client system 630, social-networking systems 660, third-party systems 670, and networks 610.

This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 650 may connect client system 630, social-networking system 660, and third-party system 670 to communication network 610 or to each other. This disclosure contemplates any suitable links 650. In particular examples, one or more links 650 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links 650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 need not necessarily be the same throughout network environment 600. One or more first links 650 may differ in one or more respects from one or more second links 650.

In particular examples, client system 630 may be an electronic device including hardware, software, or embedded logic components or a combination of two or more such components and capable of carrying out the appropriate functionalities implemented or supported by client system 630. As an example and not by way of limitation, a client system 630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 630. A client system 630 may enable a network user at client system 630 to access network 610. A client system 630 may enable its user to communicate with other users at other client systems 630.

In particular examples, client system 630 may include a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 630 may enter a Uniform Resource Locator (URL) or other address directing the web browser 632 to a particular server (such as server 662, or a server associated with a third-party system 670), and the web browser 632 may generate a Hyper Text Transfer Protocol (HTTP) request and communicate the HTTP request to server. The server may accept the HTTP request and communicate to client system 630 one or more Hyper Text Markup Language (HTML) files responsive to the HTTP request. Client system 630 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular desires. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular examples, social-networking system 660 may be a network-addressable computing system that can host an online social network. Social-networking system 660 may generate, store, receive, and send social-networking data, such as, for example, user-profile data, concept-profile data, social-graph information, or other suitable data related to the online social network. Social-networking system 660 may be accessed by the other components of network environment 600 either directly or via network 610. As an example and not by way of limitation, client system 630 may access social-networking system 660 using a web browser 632, or a native application associated with social-networking system 660 (e.g., a mobile social-networking application, a messaging application, another suitable application, or any combination thereof) either directly or via network 610. In particular examples, social-networking system 660 may include one or more servers 662. Each server 662 may be a unitary server or a distributed server spanning multiple computers or multiple datacenters. Servers 662 may be of various types, such as, for example and without limitation, web server, news server, mail server, message server, advertising server, file server, application server, exchange server, database server, proxy server, another server suitable for performing functions or processes described herein, or any combination thereof. In particular examples, each server 662 may include hardware, software, or embedded logic components or a combination of two or more such components for carrying out the appropriate functionalities implemented or supported by server 662. In particular examples, social-networking system 660 may include one or more data stores 664. Data stores 664 may be used to store various types of information. In particular examples, the information stored in data stores 664 may be organized according to specific data structures. In particular examples, each data store 664 may be a relational, columnar, correlation, or other suitable database. Although this disclosure describes or illustrates particular types of databases, this disclosure contemplates any suitable types of databases. Particular examples may provide interfaces that enable a client system 630, a social-networking system 660, or a third-party system 670 to manage, retrieve, modify, add, or delete, the information stored in data store 664.

In particular examples, social-networking system 660 may store one or more social graphs in one or more data stores 664. In particular examples, a social graph may include multiple nodes—which may include multiple user nodes (each corresponding to a particular user) or multiple concept nodes (each corresponding to a particular concept)—and multiple edges connecting the nodes. Social-networking system 660 may provide users of the online social network the ability to communicate and interact with other users. In particular examples, users may join the online social network via social-networking system 660 and then add connections (e.g., relationships) to a number of other users of social-networking system 660 to whom they want to be connected. Herein, the term “friend” may refer to any other user of social-networking system 660 with whom a user has formed a connection, association, or relationship via social-networking system 660.

In particular examples, social-networking system 660 may provide users with the ability to take actions on various types of items or objects, supported by social-networking system 660. As an example and not by way of limitation, the items and objects may include groups or social networks to which users of social-networking system 660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 660 or by an external system of third-party system 670, which is separate from social-networking system 660 and coupled to social-networking system 660 via a network 610.

In particular examples, social-networking system 660 may be capable of linking a variety of entities. As an example and not by way of limitation, social-networking system 660 may enable users to interact with each other as well as receive content from third-party systems 670 or other entities, or to allow users to interact with these entities through an application programming interfaces (API) or other communication channels.

In particular examples, a third-party system 670 may include one or more types of servers, one or more data stores, one or more interfaces, including but not limited to APIs, one or more web services, one or more content sources, one or more networks, or any other suitable components, e.g., that servers may communicate with. A third-party system 670 may be operated by a different entity from an entity operating social-networking system 660. In particular examples, however, social-networking system 660 and third-party systems 670 may operate in conjunction with each other to provide social-networking services to users of social-networking system 660 or third-party systems 670. In this sense, social-networking system 660 may provide a platform, or backbone, which other systems, such as third-party systems 670, may use to provide social-networking services and functionality to users across the Internet.

In particular examples, a third-party system 670 may include a third-party content object provider. A third-party content object provider may include one or more sources of content objects, which may be communicated to a client system 630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular examples, social-networking system 660 also includes user-generated content objects, which may enhance a user's interactions with social-networking system 660. User-generated content may include anything a user can add, upload, send, or “post” to social-networking system 660. As an example and not by way of limitation, a user communicates posts to social-networking system 660 from a client system 630. Posts may include data such as status updates or other textual data, location information, photos, videos, links, music or other similar data or media. Content may also be added to social-networking system 660 by a third-party through a “communication channel,” such as a newsfeed or stream.

In particular examples, social-networking system 660 may include a variety of servers, sub-systems, programs, modules, logs, and data stores. In particular examples, social-networking system 660 may include or a combination of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 660 may also include suitable components such as network interfaces, security mechanisms, load balancers, failover servers, management-and-network-operations consoles, other suitable components, or any suitable combination thereof. In particular examples, social-networking system 660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 660 to one or more client systems 630 or one or more third-party system 670 via network 610. The web server may include a mail server or other messaging functionality for receiving and routing messages between social-networking system 660 and one or more client systems 630. An API-request server may allow a third-party system 670 to access information from social-networking system 660 by calling one or more APIs. An action logger may be used to receive communications from a web server about a user's actions on or off social-networking system 660. In conjunction with the action log, a third-party-content-object log may be maintained of user exposures to third-party-content objects. A notification controller may provide information regarding content objects to a client system 630. Information may be pushed to a client system 630 as notifications, or information may be pulled from client system 630 responsive to a request received from client system 630. Authorization servers may be used to enforce one or more privacy settings of the users of social-networking system 660. A privacy setting of a user determines how particular information associated with a user can be shared. The authorization server may allow users to opt in to or opt out of having their actions logged by social-networking system 660 or shared with other systems (e.g., third-party system 670), such as, for example, by setting appropriate privacy settings. Third-party-content-object stores may be used to store content objects received from third parties, such as a third-party system 670. Location stores may be used for storing location information received from client systems 630 associated with users. Advertisement-pricing modules may combine social information, the current time, location information, or other suitable information to provide relevant advertisements, in the form of notifications, to a user.

In some examples, the social-networking system 660 may generate a dialog tree during an offline process. The client system 630 may execute an application that relies on the dialog tree for dialog. The dialog tree may be stored in the social-networking system 660 accessed based on data (e.g., sensed data) and application usage details (e.g., NPC position in a game, which NPC a PC is interacting with, etc.) that is provided from the client system 630 through links 650 and network 610. In some examples, a GAI may be trained based on data (e.g., dialogue from social graph stored in the data store 664). Doing so may provide a more realistic approach to dialogue generation.

### Social Graphs

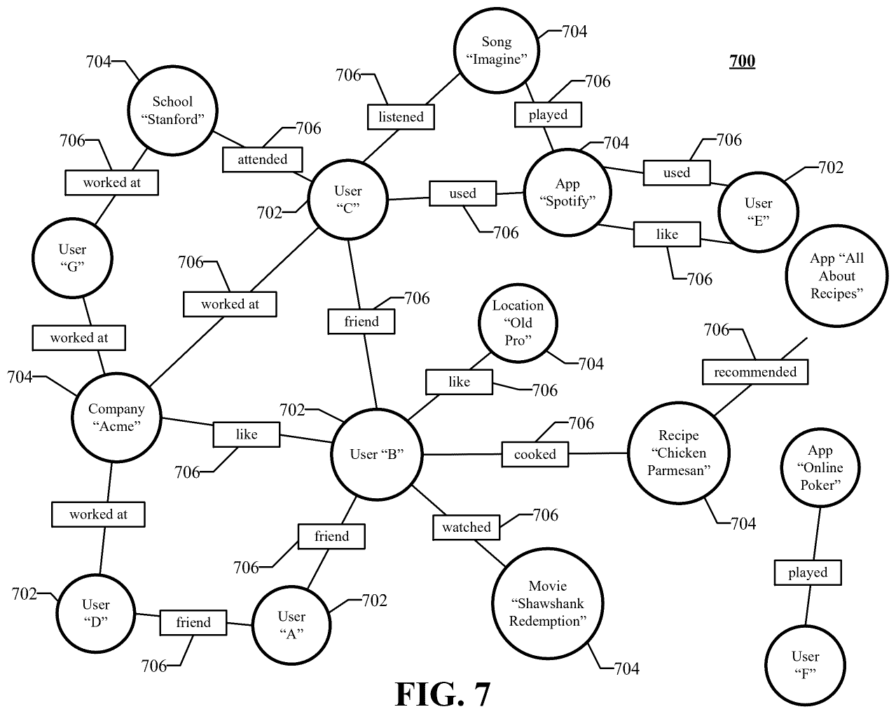

FIG. 7 illustrates example social graph 700. In some examples, the dialog process 100 (FIG. 1), dialog generation process 150 (FIG. 2), method 190 (FIG. 3), method 200 (FIG. 4), method 230 (FIG. 5), and/or network environment 600 (FIG. 6) already discussed may access social graph 700 to implement one or more aspects.

In particular examples, social-networking system 660 may store one or more social graphs 700 in one or more data stores. In particular examples, social graph 700 may include multiple nodes-which may include multiple user nodes 702 or multiple concept nodes 704 and multiple edges 706 connecting the nodes. Each node may be associated with a unique entity (i.e., user or concept), each of which may have a unique identifier (ID), such as a unique number or username. Example social graph 700 illustrated in FIG. 7 is shown, for didactic purposes, in a two-dimensional visual map representation. In particular examples, a social-networking system 660, client system 630, or third-party system 670 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular examples, a user node 702 may correspond to a user of social-networking system 660. As an example and not by way of limitation, a user may be an individual (human user), an entity (e.g., an enterprise, business, or third-party application), or a group (e.g., of individuals or entities) that interacts or communicates with or over social-networking system 660. In particular examples, when a user registers for an account with social-networking system 660, social-networking system 660 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 660. In particular examples, a user node 702 may be associated with information provided by a user or information gathered by various systems, including social-networking system 660. As an example and not by way of limitation, a user may provide his or her name, profile picture, contact information, birth date, sex, marital status, family status, employment, education background, preferences, interests, or other demographic information. In particular examples, a user node 702 may be associated with one or more data objects corresponding to information associated with a user. In particular examples, a user node 702 may correspond to one or more webpages.

In particular examples, a concept node 704 may correspond to a concept. As an example and not by way of limitation, a concept may correspond to a place (such as, for example, a movie theater, restaurant, landmark, or city); a website (such as, for example, a website associated with social-network system 660 or a third-party website associated with a web-application server); an entity (such as, for example, a person, business, group, sports team, or celebrity); a resource (such as, for example, an audio file, video file, digital photo, text file, structured document, or application) which may be located within social-networking system 660 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 660. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular examples, a concept node 704 may be associated with one or more data objects corresponding to information associated with concept node 704. In particular examples, a concept node 704 may correspond to one or more webpages.

In particular examples, a node in social graph 700 may represent or be represented by a webpage (which may be referred to as a “profile page”). Profile pages may be hosted by or accessible to social-networking system 660. Profile pages may also be hosted on third-party websites associated with a third-party system 670. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular examples, a concept node 704 may represent a third-party webpage or resource hosted by a third-party system 670. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the Icons (e.g., “check-in”), causing a client system 630 to send to social-networking system 660 a message indicating the user's action. In response to the message, social-networking system 660 may create an edge (e.g., a check-in-type edge) between a user node 702 corresponding to the user and a concept node 704 corresponding to the third-party webpage or resource and store edge 706 in one or more data stores.

In particular examples, a pair of nodes in social graph 700 may be connected to each other by one or more edges 706. An edge 706 connecting a pair of nodes may represent a relationship between the pair of nodes. In particular examples, an edge 706 may include or represent one or more data objects or attributes corresponding to the relationship between a pair of nodes. As an example and not by way of limitation, a first user may indicate that a second user is a “friend” of the first user. In response to this indication, social-networking system 660 may send a “friend request” to the second user. If the second user confirms the “friend request,” social-networking system 660 may create an edge 706 connecting the first user's user node 702 to the second user's user node 702 in social graph 700 and store edge 706 as social-graph information in one or a combination of data stores 664. In the example of FIG. 7, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706. The degree of separation between two objects represented by two nodes, respectively, is a count of edges in a shortest path connecting the two nodes in the social graph 700. As an example and not by way of limitation, in the social graph 700, the user node 702 of user “C” is connected to the user node 702 of user “A” via multiple paths including, for example, a first path directly passing through the user node 702 of user “B,” a second path passing through the concept node 704 of company “Acme” and the user node 702 of user “D,” and a third path passing through the user nodes 702 and concept nodes 704 representing school “Stanford,” user “G,” company “Acme,” and user “D.” User “C” and user “A” have a degree of separation of two because the shortest path connecting their corresponding nodes (i.e., the first path) includes two edges 706.

In particular examples, an edge 706 between a user node 702 and a concept node 704 may represent a particular action or activity performed by a user associated with user node 702 toward a concept associated with a concept node 704. As an example and not by way of limitation, as illustrated in FIG. 7, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 660 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 660 may create a “listened” edge 706 and a “used” edge (as illustrated in FIG. 7) between user nodes 702 corresponding to the user and concept nodes 704 corresponding to the song and application to indicate that the user listened to the song and used the application. Moreover, social-networking system 660 may create a “played” edge 706 (as illustrated in FIG. 7) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 7 between user node 702 for user “E” and concept node 704 for “SPOTIFY”).

In particular examples, social-networking system 660 may create an edge 706 between a user node 702 and a concept node 704 in social graph 700. As an example and not by way of limitation, a user viewing a concept-profile page (such as, for example, by using a web browser or a special-purpose application hosted by the user's client system 630) may indicate that he or she likes the concept represented by the concept node 704 by clicking or selecting a “Like” icon, which may cause the user's client system 630 to send to social-networking system 660 a message indicating the user's liking of the concept associated with the concept-profile page. In response to the message, social-networking system 660 may create an edge 706 between user node 702 associated with the user and concept node 704, as illustrated by “like” edge 706 between the user and concept node 704. In particular examples, social-networking system 660 may store an edge 706 in one or more data stores. In particular examples, an edge 706 may be automatically formed by social-networking system 660 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

### Social Graph Affinity and Coefficient

In particular examples, social-networking system 660 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 670 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular examples, social-networking system 660 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular examples, social-networking system 660 may use a variety of factors to calculate a coefficient. These factors may include, for example, user actions, types of relationships between objects, location information, other suitable factors, or any combination thereof. In particular examples, different factors may be weighted differently when calculating the coefficient. The weights for each factor may be static or the weights may change according to, for example, the user, the type of relationship, the type of action, the user's location, and so forth. ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular examples, the social-networking system 660 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may Include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular examples, social-networking system 660 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular examples, social-networking system 660 may calculate a coefficient based on a user's actions. Social-networking system 660 may monitor such actions on the online social network, on a third-party system 670, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular examples, social-networking system 660 may calculate a coefficient based on the user's actions with particular types of content. The content may be associated with the online social network, a third-party system 670, or another suitable system. The content may include users, profile pages, posts, news stories, headlines, instant messages, chat room conversations, emails, advertisements, pictures, video, music, other suitable objects, or any combination thereof. Social-networking system 660 may analyze a user's actions to determine whether one or a combination of the actions indicate an affinity for subject matter, content, other users, and so forth. As an example and not by way of limitation, if a user frequently posts content related to “coffee” or variants thereof, social-networking system 660 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular examples, social-networking system 660 may calculate a coefficient based on the type of relationship between particular objects. Referencing the social graph 700, social-networking system 660 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than user nodes 702 that are connected by a friend-type edge. In other words, depending upon the weights assigned to the actions and relationships for the particular user, the overall affinity may be determined to be higher for content about the user's spouse than for content about the user's friend. In particular examples, the relationships a user has with another object may affect the weights and/or the ratings of the user's actions with respect to calculating the coefficient for that object. As an example and not by way of limitation, if a user is tagged in a first photo, but merely likes a second photo, social-networking system 660 may determine that the user has a higher coefficient with respect to the first photo than the second photo because having a tagged-in-type relationship with content may be assigned a higher weight and/or rating than having a like-type relationship with content. In particular examples, social-networking system 660 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 660 may determine that the first user should also have a relatively high coefficient for the particular object. In particular examples, the coefficient may be based on the degree of separation between particular objects. The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular examples, social-networking system 660 may calculate a coefficient based on location information. Objects that are geographically closer to each other may be considered to be more related or of more interest to each other than more distant objects. In particular examples, the coefficient of a user towards a particular object may be based on the proximity of the object's location to a current location associated with the user (or the location of a client system 630 of the user). A first user may be more interested in other users or concepts that are closer to the first user. As an example and not by way of limitation, if a user is one mile from an airport and two miles from a gas station, social-networking system 660 may determine that the user has a higher coefficient for the airport than the gas station based on the proximity of the airport to the user.

In particular examples, social-networking system 660 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 660 may provide information that is relevant to user's interests and current circumstances, increasing the likelihood that they will find such information of interest. In particular examples, social-networking system 660 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular examples, social-networking system 660 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular examples, social-networking system 660 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 670 (e.g., via an API or other communication channel), or from another suitable system. In response to the request, social-networking system 660 may calculate the coefficient (or access the coefficient information if it has previously been calculated and stored). In particular examples, social-networking system 660 may measure an affinity with respect to a particular process. Different processes (both internal and external to the online social network) may request a coefficient for a particular object or set of objects. Social-networking system 660 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular examples may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

### Privacy

In particular examples, one or a combination of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular examples, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular examples, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 704 corresponding to a particular photo may have a privacy setting specifying that the photo may only be accessed by users tagged in the photo and their friends. In particular examples, privacy settings may allow users to opt in or opt out of having their actions logged by social-networking system 660 or shared with other systems (e.g., third-party system 670). In particular examples, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 670, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular examples, one or more servers 662 may be authorization/privacy servers for enforcing privacy settings. In response to a request from a user (or other entity) for a particular object stored in a data store 664, social-networking system 660 may send a request to the data store 664 for the object. The request may identify the user associated with the request and may only be sent to the user (or a client system 630 of the user) if the authorization server determines that the user is authorized to access the object based on the privacy settings associated with the object. If the requesting user is not authorized to access the object, the authorization server may prevent the requested object from being retrieved from the data store 664, or may prevent the requested object from being sent to the user. In the search query context, an object may only be generated as a search result if the querying user is authorized to access the object. In other words, the object has a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

### Systems and Methods

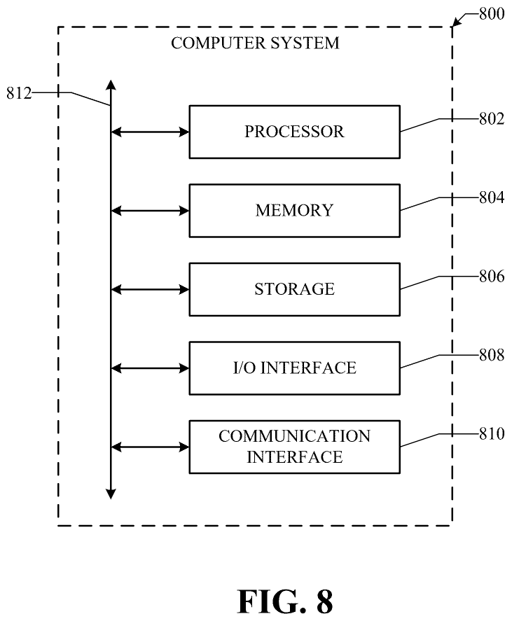

FIG. 8 illustrates an example computer system 800. The system 800 may implement one or more aspects of the dialog process 100 (FIG. 1), dialog generation process 150 (FIG. 2), method 190 (FIG. 3), method 200 (FIG. 4), method 230 (FIG. 5), and/or network environment 600 (FIG. 6) already discussed. For example, the computer system 800 may be replicated and incorporated as part of the server 126 and computing device 108 to execute aspects described with respect to FIG. 1. In particular examples, one or more computer systems 800 perform one or more steps of one or more methods described or illustrated herein. In particular examples, one or more computer systems 800 provide functionality described or illustrated herein. In particular examples, software running on one or more computer systems 800 performs one or more steps of one or more methods described or illustrated herein or provides functionality described or illustrated herein. Particular examples include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods, including method 190, method 200 and/or method 230, described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular examples, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular examples, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular examples, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular examples, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular examples, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or a combination of those results to memory 804. In particular examples, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular examples, one or more memory management units (MMUs) reside between processor 802 and memory 804 and facilitate accesses to memory 804 requested by processor 802. In particular examples, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular examples, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular examples, storage 806 is non-volatile, solid-state memory. In particular examples, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular examples, I/O interface 808 includes hardware, software, or both, providing one or more interfaces for communication between computer system 800 and one or more I/O devices. Computer system 800 may include one or a combination of these I/O devices, where appropriate. One or a combination of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or a combination of these I/O devices. I/O interface 808 may include one or more I/O interfaces 808, where appropriate. Although this disclosure describes and illustrates a particular I/O interface, this disclosure contemplates any suitable I/O interface.

In particular examples, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or a combination of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular examples, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

### EXAMPLES

Example 1 includes at least one computer readable storage medium comprising a set of instructions, which when executed by a computing device, cause the computing device to receive a first prompt associated with a character in a computing application; generate, with a first machine learning model during an offline process, first responses based on the first prompt, where the first responses are dialog of the character; store the first responses into a dialog tree during the offline process; receive a second prompt associated with an end user of the computing application; generate, with the first machine learning model during the offline process, second responses to the second prompt and based on the first responses stored in the dialog tree, where the second responses are dialog of the end user; and add the second responses to the dialog tree during the offline process.

Example 2 includes the at least one computer readable storage medium of Example 1, where the instructions, when executed, cause the computing device to identify user interactions associated with a current user of the computing application; determine an intent of the current user based on the user interactions; identify a dialog line from the dialog tree based on the intent; and transmit the dialog line to an electronic device of the current user.

Example 3 includes the at least one computer readable storage medium of Example 2, where the electronic device one or more of displays the dialog line or generates an audio output that represents the dialog line.

Example 4 includes the at least one computer readable storage medium of Example 1, where the dialog tree includes nodes and pointers that connect the nodes, where the nodes represent dialog and the pointers represent intents.

Example 5 includes the at least one computer readable storage medium of Example 1, where the first machine learning model is a generative machine learning model.

Example 6 includes the at least one computer readable storage medium of Example 1, where the instructions, when executed, cause the computing device to generate third responses in real-time during an online process when a leaf of the dialog tree is accessed.

Example 7 includes the at least one computer readable storage medium of Example 1, where the instructions, when executed, cause the computing device to generate, with a second machine learning model, the first prompt and the second prompt.

Example 8 includes a system comprising one or more processors; and a memory coupled to the one or more processors, the memory comprising instructions executable by the one or more processors, the one or more processors being operable when executing the instructions to receive a first prompt associated with a character in a computing application; generate, with a first machine learning model during an offline process, first responses based on the first prompt, where the first responses are dialog of the character; store the first responses into a dialog tree during the offline process; receive a second prompt associated with an end user of the computing application; generate, with the first machine learning model during the offline process, second responses to the second prompt and based on the first responses stored in the dialog tree, where the second responses are dialog of the end user; and add the second responses to the dialog tree during the offline process.

Example 9 includes the system of Example 8, where the one or more processors are further operable when executing the instructions to identify user interactions associated with a current user of the computing application; determine an intent of the current user based on the user interactions; identify a dialog line from the dialog tree based on the intent; and transmit the dialog line to an electronic device of the current user.

Example 10 includes the system of Example 9, where the electronic device one or more of displays the dialog line or generates an audio output that represents the dialog line.

Example 11 includes the system of Example 9, where the dialog tree includes nodes and pointers that connect the nodes, where the nodes represent dialog and the pointers represent intents.

Example 12 includes the system of Example 9, where the first machine learning model is a generative machine learning model.

Example 13 includes the system of Example 8, where the one or more processors are further operable when executing the instructions to generate third responses in real-time during an online process when a leaf of the dialog tree is accessed.

Example 14 includes the system of Example 8, where the one or more processors are further operable when executing the instructions to generate, with a second machine learning model, the first prompt and the second prompt.

Example 15 includes a method comprising receiving a first prompt associated with a character in a computing application; generating, with a first machine learning model during an offline process, first responses based on the first prompt, where the first responses are dialog of the character; storing the first responses into a dialog tree during the offline process; receiving a second prompt associated with an end user of the computing application; generating, with the first machine learning model during the offline process, second responses to the second prompt and based on the first responses stored in the dialog tree, where the second responses are dialog of the end user; and adding the second responses to the dialog tree during the offline process.

Example 16 includes the method of Example 15, further comprising identify user interactions associated with a current user of the computing application; determine an intent of the current user based on the user interactions; identify a dialog line from the dialog tree based on the intent; and transmit the dialog line to an electronic device of the current user.

Example 17 includes the method of Example 16, further comprising one or more of displaying, with the electronic device, the dialog line or generating, with the electronic device, an audio output that represents the dialog line.

Example 18 includes the method of Example 15, where the dialog tree includes nodes and pointers that connect the nodes, where the nodes represent dialog and the pointers represent intents.

Example 19 includes the method of Example 15, where the first machine learning model is a generative machine learning model.

Example 20 includes the method of Example 15, further comprising generating third responses in real-time during an online process when a leaf of the dialog tree is accessed; and generating, with a second machine learning model, the first prompt and the second prompt.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Examples are applicable for use with all types of semiconductor integrated circuit (“IC”) chips. Examples of these IC chips include but are not limited to processors, controllers, chipset components, programmable logic arrays (PLAs), memory chips, network chips, systems on chip (SOCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary examples to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although examples are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the examples. Further, arrangements may be shown in block diagram form in order to avoid obscuring examples, and also in view of the fact that specifics with respect to implementation of such block diagram arrangements are highly dependent upon the computing system within which the example is to be implemented, i.e., such specifics should be well within purview of one skilled in the art. Where specific details (e.g., circuits) are set forth in order to describe example examples, it should be apparent to one skilled in the art that examples can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the examples can be implemented in a variety of forms. Therefore, while the examples have been described in connection with particular examples thereof, the true scope of the examples should not be so limited since other modifications will become apparent to the skilled practitioner upon a study of the drawings, specification, and following claims.

We claim:

1. At least one computer readable storage medium comprising a set of instructions, which when executed by a computing device, cause the computing device to:
receive a first prompt associated with a character in a computing application;
generate, with a first machine learning model during an offline process, first responses based on the first prompt, wherein the first responses are dialog of the character;
store the first responses into a dialog tree during the offline process;
receive a second prompt associated with an end user of the computing application;
generate, with the first machine learning model during the offline process, second responses to the second prompt and based on the first responses stored in the dialog tree, wherein the second responses are dialog of the end user; and
add the second responses to the dialog tree during the offline process.

2. The at least one computer readable storage medium of claim 1, wherein the instructions, when executed, cause the computing device to:
identify user interactions associated with a current user of the computing application;
determine an intent of the current user based on the user interactions;
identify a dialog line from the dialog tree based on the intent; and
transmit the dialog line to an electronic device of the current user.

3. The at least one computer readable storage medium of claim 2, wherein the electronic device one or more of displays the dialog line or generates an audio output that represents the dialog line.

4. The at least one computer readable storage medium of claim 1, wherein the dialog tree includes nodes and pointers that connect the nodes, wherein the nodes represent dialog and the pointers represent intents.

5. The at least one computer readable storage medium of claim 1, wherein the first machine learning model is a generative machine learning model.

6. The at least one computer readable storage medium of claim 1, wherein the instructions, when executed, cause the computing device to:
generate third responses in real-time during an online process when a leaf of the dialog tree is accessed.

7. The at least one computer readable storage medium of claim 1, wherein the instructions, when executed, cause the computing device to:
generate, with a second machine learning model, the first prompt and the second prompt.

8. A system comprising:
one or more processors; and
a memory coupled to the one or more processors, the memory comprising instructions executable by the one or more processors, the one or more processors being operable when executing the instructions to:
receive a first prompt associated with a character in a computing application;
generate, with a first machine learning model during an offline process, first responses based on the first prompt, wherein the first responses are dialog of the character;
store the first responses into a dialog tree during the offline process;
receive a second prompt associated with an end user of the computing application;
generate, with the first machine learning model during the offline process, second responses to the second prompt and based on the first responses stored in the dialog tree, wherein the second responses are dialog of the end user; and
add the second responses to the dialog tree during the offline process.

9. The system of claim 8, wherein the one or more processors are further operable when executing the instructions to:
identify user interactions associated with a current user of the computing application;
determine an intent of the current user based on the user interactions;
identify a dialog line from the dialog tree based on the intent; and
transmit the dialog line to an electronic device of the current user.

10. The system of claim 9, wherein the electronic device one or more of displays the dialog line or generates an audio output that represents the dialog line.

11. The system of claim 8, wherein the dialog tree includes nodes and pointers that connect the nodes, wherein the nodes represent dialog and the pointers represent intents.

12. The system of claim 8, wherein the first machine learning model is a generative machine learning model.

13. The system of claim 8, wherein the one or more processors are further operable when executing the instructions to:
generate third responses in real-time during an online process when a leaf of the dialog tree is accessed.

14. The system of claim 8, wherein the one or more processors are further operable when executing the instructions to:
generate, with a second machine learning model, the first prompt and the second prompt.

15. A method comprising:
receiving a first prompt associated with a character in a computing application;
generating, with a first machine learning model during an offline process, first responses based on the first prompt, wherein the first responses are dialog of the character;
storing the first responses into a dialog tree during the offline process;
receiving a second prompt associated with an end user of the computing application;
generating, with the first machine learning model during the offline process, second responses to the second prompt and based on the first responses stored in the dialog tree, wherein the second responses are dialog of the end user; and
adding the second responses to the dialog tree during the offline process.

16. The method of claim 15, further comprising:
identifying user interactions associated with a current user of the computing application;
determining an intent of the current user based on the user interactions;
identifying a dialog line from the dialog tree based on the intent; and
transmitting the dialog line to an electronic device of the current user.

17. The method of claim 16, further comprising:
one or more of displaying, with the electronic device, the dialog line or generating, with the electronic device, an audio output that represents the dialog line.

18. The method of claim 15, wherein the dialog tree includes nodes and pointers that connect the nodes, wherein the nodes represent dialog and the pointers represent intents.

19. The method of claim 15, wherein the first machine learning model is a generative machine learning model.

20. The method of claim 15, further comprising:
generating third responses in real-time during an online process when a leaf of the dialog tree is accessed; and
generating, with a second machine learning model, the first prompt and the second prompt.
